(19) United States
(12) Patent Application Publication
(10) Pub. No.: US 2002/0111078 A1
(43) Pub. Date: Aug. 15, 2002

(54) Keying devices for modular systems

(76) Inventors: Richard G. Sevier, Boise, ID (US); Kristi Scott, Roseville, CA (US)

Correspondence Address: HEWLETT-PACKARD COMPANY, Intellectual Property Administration, P.O. Box 272400, Fort Collins, CO, 80527-2400, US

(21) Appl. No.: 09/782,995

(22) Filed: Feb. 12, 2001

(51) Int. Cl. H01R 3/00; H01R 13/64

(52) U.S. Cl. 439/680; 439/488

(57) ABSTRACT

A computer module/module chassis system is provided with a keying system having a binomial design having 2^{X} keying arrangements where X is the number of bits or keying elements in the keying system. The keying system is especially useful in preventing misinstallation of a module in a slot having an incompatible electrical connection system. The usefulness of this keying system is enhanced by the fact that it can be installed late in the manufacturing process or at an installation site.

### BACKGROUND OF THE INVENTION

1. Field of the Invention

This invention generally relates to keying devices for module systems. More particularly, it relates to keying devices for computer peripheral modules having the same, or confusingly similar, physical sizes. Such keying devices are used to prevent module installation mistakes.

2. Description of Related Art

Many computer systems include a cabinet or chassis which houses a number of modules having similar, if not identical, physical dimensions. Thus, the cabinet will have a number of similar or identical module-receiving slots. The modules might include mass storage devices, central processing units, controllers for input-output devices and power supplies. These modules sometimes need to be repaired, updated or augmented with additional modules. Repair usually involves removing a defective module and replacing it with a correctly functioning module of the same type. Some computer systems even go so far as to incorporate redundant modules so that a given module can be removed and repaired while the remainder of the system remains in operation.

Obviously, when a repaired module is replaced (or when an additional module is placed in an open slot in a module chassis), it is essential that the subject module be of the correct type. If a module of one type is inserted into a site designed for a module of a different type, serious damage may occur to the module and/or to the entire computer system. Valuable data can be lost as well.

Obvious differences in the shape of many modules precludes their insertion into an open slot in a chassis that is not designed to receive that particular module. For example, a hard disk drive unit and a power supply unit normally are of very different sizes and shapes. Moreover, they have electrical connectors that are mechanically incompatible. Therefore, it is virtually impossible to insert either of these two module types into a slot designed for the other—and then electrically connect such a misinstalled unit. Other types of modules are, however, purposely designed in a standard physical form so that they can be inserted into physically identical slots in a common housing. Consequently, owing to the fact that electrical connections to modules of different types usually differ, electrical component damage may result from the fact that an appropriately sized module is mistakenly installed in a slot whose electrical connections are not designed to accept that module. And even if there is no damage to the hardware, loss of its functionality may result from misinstallation of a given module.

The prior art has recognized that misinstallations of this kind can be precluded by placement of a first mechanical keying device at the face of a given module-receiving slot in a housing, and placing a second mechanically cooperating keying device at the rear end of a module that may otherwise physically fit into the module-receiving slot. For example, U.S. Pat. No. 5,733,149 (“the '149 patent”) teaches a computer peripheral module having keying elements that are molded into a front corner of the module. The module can be inserted into a receiving slot in the chassis only if keying holes molded into the front of the module mechanically cooperate with keying pins in the intended receiving slot in the chassis. Thus these cooperating keying elements ensure that the module can only be inserted into the correct receiving slot, thereby protecting the mechanical and electrical functioning of that module.

Such molding of the key elements into the module housing requires complicated and costly molding procedures, including mechanical core pulls of an injection mold system. Moreover, such molding operations represent a commitment to a given key system at a very early stage of the manufacturing process i.e., when the module housing unit is first molded into its intended shape. Such “molded in” keying systems work well enough in those parts of a computer system where a given slot is intended to accept one and only one type of module. They do not, however, work very well in module systems where the slots are designed to accommodate any one of several different types of modules having the same physical dimensions. For example, in some computer systems each input/output controller is comprised of two identically sized modules. The first module normally contains most of the logic board circuitry of the controller. The second module usually contains specialized interface circuitry that is electrically connected to other components of the computer device, or to a communication line. If the first or second module is plugged into the wrong slot, damage may result from electrical arcing or power supply voltage drops.

Consequently, methods for preventing power delivery to an incompatible module/module-receiver slot also have been proposed. For example, U.S. Pat. No. 4,800,462 (“the '462 patent”) discloses an electromechanical interconnect system for interconnecting a set of pin-compatible module pairs in a manner such that power delivery to electrically incompatible modules is precluded. More specifically, the module includes a control switch having two control terminals. Each terminal is connected to a keying connector. Keying connectors on various modules are coupled so that the control terminals are only conductively connected when electrically compatible modules are interconnected. It should be noted, however, that electrical keying systems of this kind perform their electrical power damage prevention function only after the module has been fully installed in the receiver slot.

From a manufacturing standpoint, it is extremely advantageous in module-oriented products, such as disk arrays or controller systems, to use as many components for as many different applications as possible. This allows better use of design and manufacturing resources to create as many products as possible using as many commonly used parts as possible. For example, a module chassis may be provided with a number of slots to receive similarly shaped disk arrays, controller systems, power supplies, fans, etc. The extended use of such common hardware components requires a substantial amount of physical commonality between the chassis enclosures and the modules they house. As a general rule, a manufacturer usually wants to preserve a given item's individuality as long in the manufacturing process as possible. Stated another way, a manufacturer wishes to distinguish a given item as late in the manufacturing process as possible. On the other hand, in order to create different products, one or more modules of a computer system will be made different from their predecessor modules in order to provide some different functionality. Thus, an inherent tension exists between the economic desire to use as many common parts as possible (for as long in the manufacturing process as possible) and the desire to improve module-oriented products.

The prior art keying systems noted above have not fully solved the above noted manufacturing economy versus end product versatility dilemma. For example, keying based upon molding a keying system into the module (a la the teachings of the '149 patent) must be carried out very early in the manufacturing process. Consequently, permanent commitment to a given key design is made at this early stage. This commitment will to some degree limit or even prevent future change in the module system. It also makes keying changes impossible in the field. Keying done at the electrical connection level (a la the teachings of the '462 patent) also is done relatively early in the manufacturing process. It also requires substantial or complete installation of the module before its “incorrectness” is determined. At the very least, valuable time is lost in misinstalling an electrically incompatible module.

Thus, there is a continuing need to prevent similarly sized, but electrically incompatible, modules from being inserted into “wrong” module-receiving slots. Preferably, such a misinstallation prevention device will be entirely mechanical in nature and function at the very first attempt to misinstall a module. Such a device also should be capable of being easily installed late in the manufacturing process (e.g., long after the module molding and chassis construction processes have taken place). Indeed, in its most preferred embodiments, such a device would be an accessory item capable of being installed in the field, i.e., at a computer installation site. This ability to install such a device at an installation site greatly widens the possibilities for future product modifications. Keying expandability, low cost and portability also are desirable attributes in such devices. The keying devices of this patent disclosure provide all of these desirable attributes.

### SUMMARY OF THE INVENTION

Generally speaking, use of applicant's invention will produce a computer module system comprising: (1) a chassis having two or more substantially identically-configured slots and wherein at least one of said two or more slots is provided with a first binomial keying element; and (2) at least two modules each having a substantially identical configuration and capable of being inserted into the two or more slots in the chassis and wherein at least one of said two modules is provided with a second binomial keying element that mechanically cooperates with the first binomial keying element to prevent misinstallation of a module. The mechanically cooperating first and second binomial keying elements thus, together, constitute applicant's binomial keying system.

The binomial keying systems of this patent disclosure mechanically cooperate (or fail to cooperate) near the rear end of the module and near the front end of the slots. Preferably these binomial keying systems employ “snap on” or otherwise easily installed, and easily removed, first and second binomial keying elements. That is to say that these first and second binomial keying elements are preferably in the nature of accessory items, wherein the term “accessory” can be taken to mean that the first and second binomial keying elements (and hence the keying systems) of this patent disclosure can be installed at an end point installation site using easily transportable tools (e.g., screwdrivers, pliers, wrenches, drills and the like). Obviously, if these keying devices can be installed in the field, they can be installed during the module/chassis manufacturing processes as well.

The individual first and second binomial keying elements of the binomial keying systems of this patent disclosure can be positioned on the top, bottom or side of the module they are to protect. Preferably, applicant's binomial keying systems will have a three bit or four bit design. In some of the more preferred embodiments of this invention, the binomial keying system will be comprised of 3 bits having lug elements and lug passage keyway elements that are rectangular (or square) in configuration. The lug passage keyway elements allow an appropriate lug to pass through an appropriate lug passage keyway element. Such keys can be installed very late in the manufacturing process. Indeed, they even can be changed in the field should replacement modules be required by reason of upgrading and/or so-called rolling manufacturing changes. Again, the binomial keying systems of this patent disclosure can be thought of as “accessory items”. Thus, their use anywhere in the manufacturing process (or installation process) does not foreclose future changes in a modular product. Again, there are great practical and economic advantages associated with keying module/chassis systems “late” in the manufacturing process or at the installation site. Moreover, the binomial keying devices of this patent disclosure readily permit keying expandability owing to their use of certain readily expandable binomial keying concepts hereinafter more fully described. In these descriptions, computer module/chassis systems will be used to illustrate this invention. It should be appreciated however that the binomial keying systems of this patent disclosure also could be used in other chassis-housed module systems (including spare parts drawers) where there is a need to keep a module in a “correct” slot. Preferably, the keying elements can be installed and/or set up using simply hand tools or hand operated key element set up mechanisms.

### BRIEF DESCRIPTION OF THE DRAWINGS

FIG. 1 is a perspective view of a representative prior art module array in a module chassis.

FIG. 2 is a front view (or rear view) of a module/module chassis system provided with a keying system designed according to the general teachings of this patent disclosure.

FIG. 3 is a perspective view of a module provided with a keying system based upon the teachings of the present patent disclosure, about to be inserted into a keyed slot in a module chassis.

FIG. 4 is a perspective view of a module, provided with a keying system on its right side, about to be inserted into a cooperating keyed slot in a module chassis.

FIG. 5 is a detailed side view of a module provided with a donor key component and a chassis receiver slot that is shown provided with a donor key passing component.

FIG. 6 is a side view of the module/slot system shown in FIG. 5 wherein the module is partially inserted into the slot.

FIG. 7 is a side view of the module/slot system shown in FIG. 5 wherein the module is fully inserted into the slot.

FIG. 8 is a side view of a module provided with a donor key passing component and a chassis receiving slot that is provided with a donor key component.

FIG. 9 is a side view of the module/slot system shown in FIG. 8 wherein the module is partially inserted into the slot.

FIG. 10A depicts a keying system having a 3 bit design and a binary value of zero.

FIG. 10B depicts a keying system having a 3 bit design and a binary value of 1.

FIG. 10C depicts a keying system having a 3 bit design and a binary value of 2.

FIG. 10D depicts a keying system having a 3 bit design and a binary value of 7.

FIG. 11 depicts an instance where the keying system has assured that the module and the chassis slot are properly associated.

FIG. 12 depicts an instance where the keying system has prevented an improper module/chassis slot association.

FIG. 13 shows a lug passage element attachably mounted on top of a module chassis.

FIG. 14 shows a binomial keying device of this patent disclosure having four rectangular keying elements.

FIG. 15 shows a binomial keying device of this patent disclosure having five round keying elements.

### DETAILED DESCRIPTION OF THE INVENTION

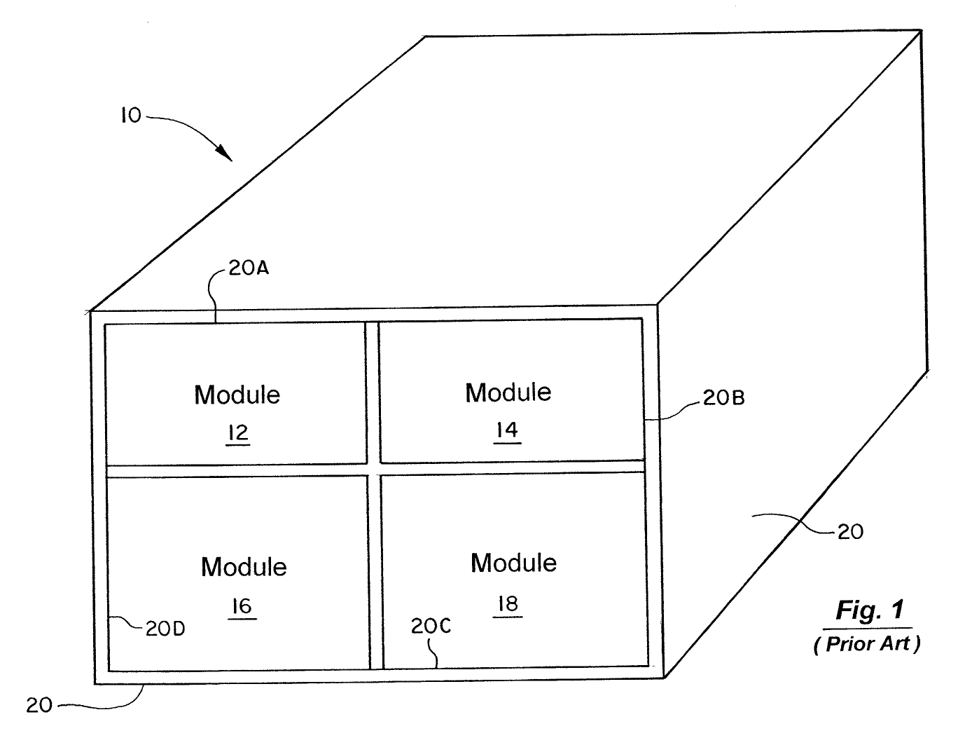

FIG. 1 shows a prior art module/chassis system 10. Such a system is generally comprised of an array of modules 12, 14, 16 and 18 in a chassis or housing 20. These modules may be installed from the front end of the chassis 20, or from its rear end. Thus, FIG. 1 could just as well be a rear view of the module/chassis system 10. For the sake of simplicity, the chassis 20 of FIG. 1 is shown provided with four slots (20A, 20B, 20C and 20D) that respectively receive modules 12, 14, 16 and 18. Those skilled in this art will however appreciate that such a chassis could have many more such slots. Moreover, several such chassis could be placed side by side to produce systems having very large numbers of module-receiver slots of several different sizes.

FIG. 1 also illustrates the circumstances that create the need for the present invention. Module 12 (residing in slot 20A) has the same cross sectional configuration and size as module 14 (residing in slot 20B). Hence, module 12 could be mistakenly placed in slot 20B. Module 14 could likewise be mistakenly installed in slot 20A. The same possibility for misinstallation exists with respect to modules 16 and 18. That is to say that module 16 is larger than modules 12 and 14 and therefore will not fit into slots 20A or 20B, but module 16 could be misinstalled in slot 20C since it is of the same size as module 18. Hence, both sets of modules (12/14 and 16/18) could benefit from a keying system that prevents misinstallations. Again, those skilled in this art also will appreciate that many computer module chassis units have many more module-receiver slots than the four (20A, 20B, 20C and 20D) shown in FIG. 1. Hence, as the number of such slots increases, so does the potential for misinstallation of any given module unit having a physical size that is substantially the same as other modules in the subject module system.

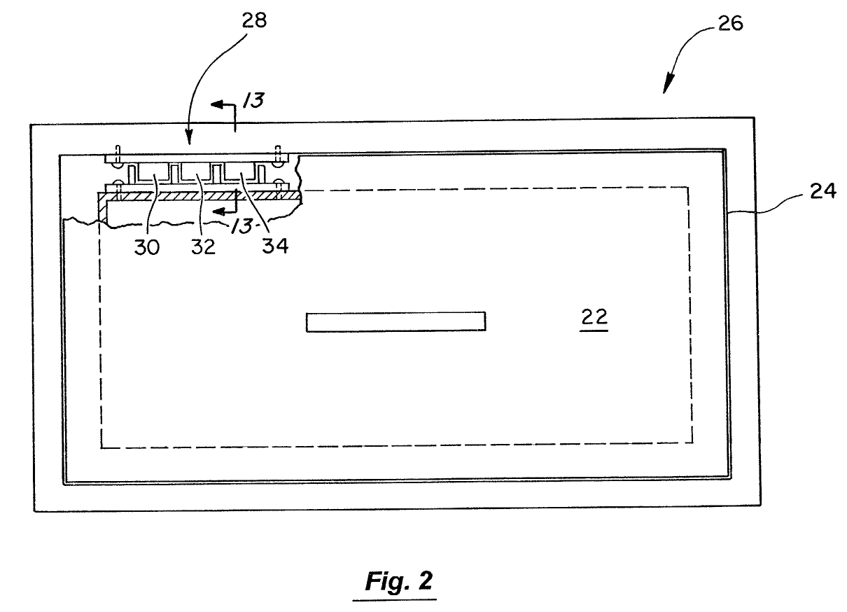

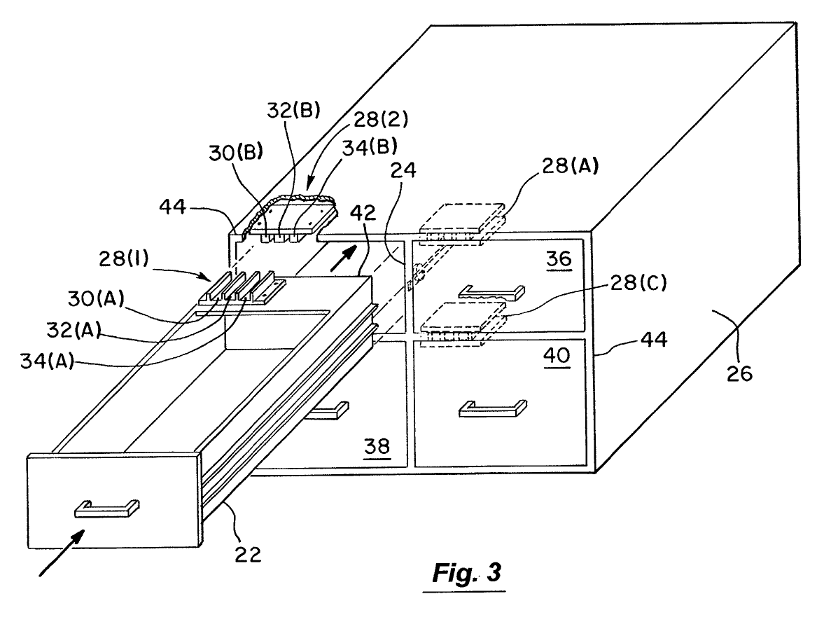

FIG. 2 shows a generalized front view (or rear view) of a module 22 inserted in a slot 24 of a chassis 26 (such as the chassis 26 depicted in FIG. 3). FIG. 2 also shows a generalized binomial keying system 28 located in the upper left corner of the slot 24. The generalized binomial keying system 28 is intended to depict a binary system having three bits or keying elements 30, 32 and 34. Because this system is binary in nature, each bit or keying element can be thought of as being in one of two states (yes/no, go/no-go, positive/negative, male/female, etc.). Thus, the number of possible keyed configurations is 2^{x} where X is the number of bits or keying elements. This number could be quite large; but as a practical matter keying systems wherein X is from 2 to 5 are highly preferred for the practice of this invention. In the system shown in FIG. 2 for example, the number of keying possibilities is 2³ or 8. If the number of bits or keying elements were 4 (as depicted in FIG. 14), the number of keying possibilities would be 2⁴ or 16, and so on.

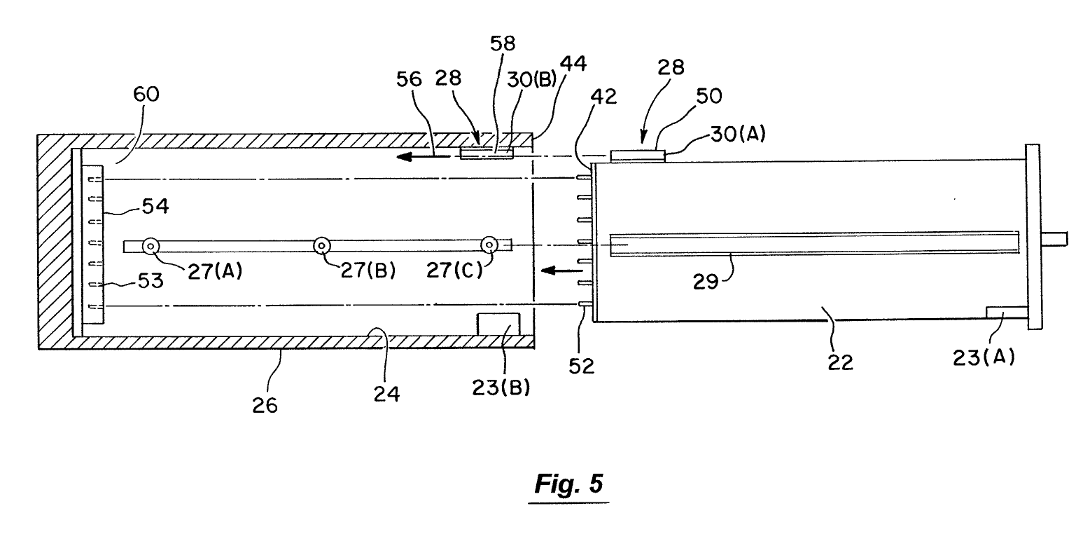

FIG. 3 is a perspective view of a chassis 26 designed to house four modules (22, 36, 38 and 40). Module 22 can be regarded as being identical to the module 22 depicted in FIG. 2. These four modules are shown provided with respective binomial keying systems 28, 28(A) . . . 28(C) that are each comparable to the binomial keying system 28 shown in FIG. 2. In FIG. 3, module 22 is shown about to be inserted into slot 24 of chassis 26. Such a module can have any cross sectional (e.g., rectangular, square, round, parallelepiped, etc.), but rectangular modules are by far the most common and therefore will be used as an example throughout this patent disclosure. In any case, the first binomial keying element 28(1) associated with a module, such as module 22, is preferably mounted near the rear end 42 of a given module such as module 22. In all cases, the keying element 28(1) should be positioned such that it (in conjunction with a second binomial keying element) prohibits engagement of an electrical connector element of a module with an inappropriate electrical connector element of a chassis. The second binomial keying element 28(2) associated with a slot such as slot 24 is likewise preferably mounted at (or near, e.g., within 3 inches of) the front face 44 of the chassis 26. Thus, if the key bit elements 30(B), 32(B) and 34(B) mounted on the front 44 of the chassis 26 are not all properly cooperating with their counterpart key bit elements 30(A), 32(A) and 34(A) on the rear 42 of the module 22, the module 22 will be “blocked”, rejected, etc. as soon as one tries to install (i.e., misinstall) said module 22 in slot 24. As can be better seen in FIG. 5, the module 22 also can be provided with a lock element (not shown), e.g., in its lower left rear corner region (or its lower right rear corner region). Such a lock element could cooperate, in known ways, with a second lock element (not shown) on the lower, left, front corner (or lower right front corner) of slot 24 to securely hold the module 22 in the slot 24 once said module 22 is fully installed (see also FIG. 5).

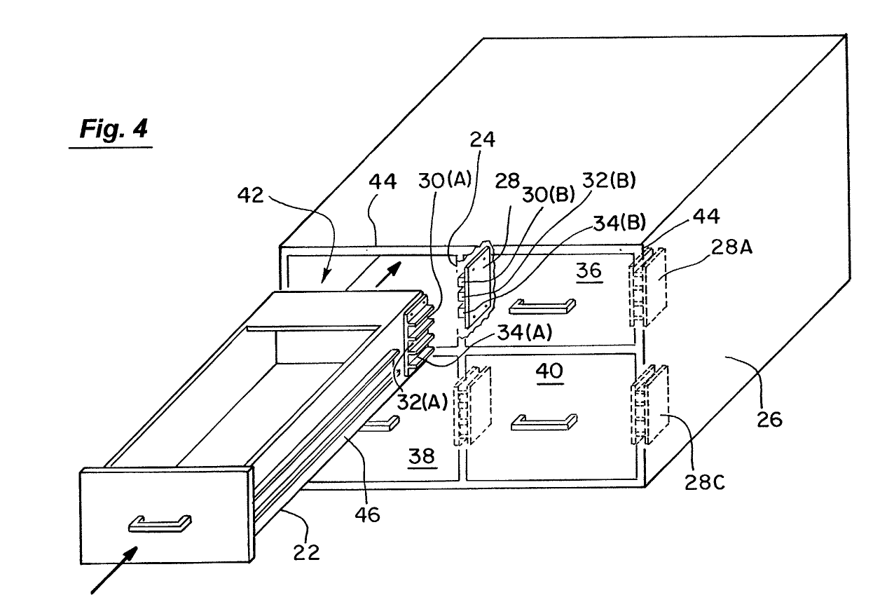

FIG. 4 is another perspective view of a chassis 26 designed to house four modules (22, 36, 38 and 40). In this system however, the keying systems 28, 28(A), 28(B), 28(C) are positioned near the center of the right side of each of the four respective module-receiving slots. Thus, module 22 is shown having the three key bit elements 30(A), 32(A), 34(A) of its first binomial keying element 28(1) located near the center of the front end 42 of its right side 46. The location of these keying elements is not, however, in any sense crucial. They can be on the top, bottom or sides of the module 22.

FIG. 5 is a side view of a portion of the chassis/module system shown in FIG. 3. It depicts a module 22 about to be installed in a receiving slot 24 of a chassis 26. To aid in such operations the slot 24 is shown provided with rollers 27(A), 27(B) and 27(C) that are inserted in a channel 29 on the side of module 22. Such roller/channel arrangements are well known in the chassis/drawer making arts. The keying system 28 depicted in FIG. 5 is shown positioned to prevent insertion of the module 22 into slot 24 if its lug element 30(A) does not pass through the lug passage keyway 30(B) in the appropriate key bit element in the face 44 of the slot 24. Thus, FIG. 5 shows an embodiment of the present invention wherein key bit element 30(B) of the binomial keying system 28 is an open passage keyway 58 that receives and passes a lug 50 that constitutes key bit element 30(A).

FIG. 5 also shows the module 22 provided with a pin system 52 for making an appropriate electrical connection between the module 22 and an electrical connector located in the rear end of the slot 24. The individual pins in the array of pins in pin system 52 are intended to be received into a cooperating pin holes 53 having the proper pin hole sizes and locations relative to the individual pins in the pin system 52. In other words, the array of pins in pin system 52 are intended to fit into a mechanically cooperating array of pin-receiving holes 53 in a pin receiving block 54 positioned in the rear of slot 24. Assuming proper mechanical cooperation between the pins and pin holes, a proper electrical connection can be made between the module 22 and the pin-receiver block 54.

Those skilled in the computer peripheral manufacturing arts will of course appreciate that many Personal Computer Memory Card International Association (“PCMCIA”) form factors have become de facto standards for certain computer peripherals such as memory, disk drives and modems. Even components that are designed to be permanently built into a host device typically abide by these form factors. For example, one often employed PCMCIA standard defines a 68-pin interface between a pin array and a socket or slot into which it is inserted. Included in that specification is a requirement for connector end keying, which prevents mismatched, connecting elements from being mated. Consequently, this invention is also concerned with assuring that modules of the same physical size also conform to a predetermined PCMCIA standard that calls for use of a keying system. Be these PCMCIA standards as they may, FIG. 5 suggests that the mating between the individual pins in the pin system 52 and the individual pin-receiving holes 53 in the pin receiver block 54 of FIG. 5 will only take place if the lug 50 that comprises bit element 30(A) passes completely through the lug passage keyway 48 that comprises key bit element 30(B). This passage is suggested by arrow 56. This passage assumes that the other two bit element components (32(B)/32(A) and 34(B)/34(A)) also have mechanically cooperated in the manner prescribed by a previous key setup operation.

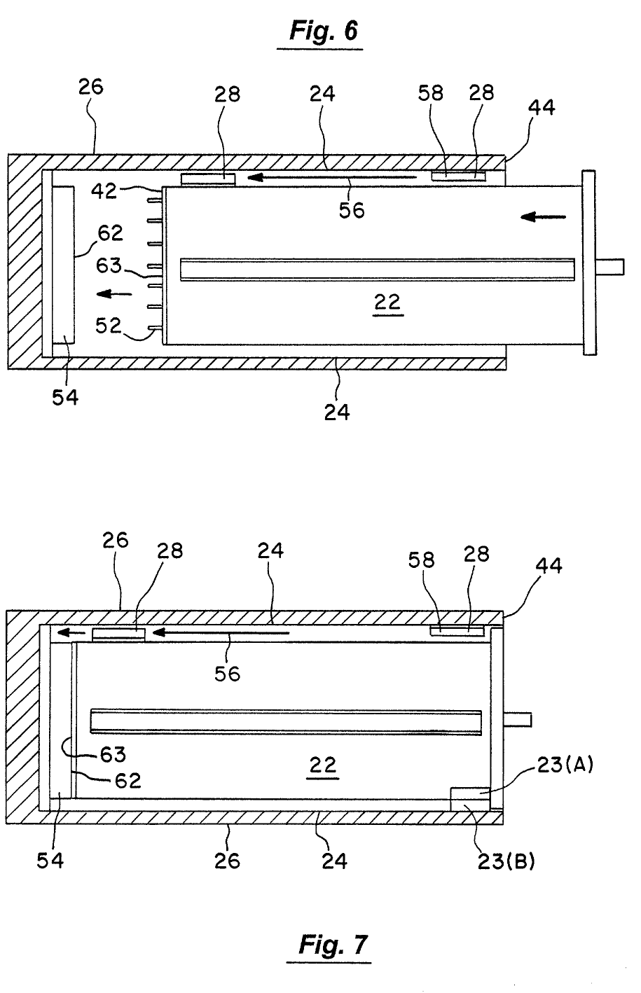

FIG. 6 shows the results of all three key bit elements (30(B), 32(B), 34(B)) on the chassis 26 successfully cooperating with all three of their counterpart key bit elements 30(A), 32(A) and 34(A) on the module 22. Thus, FIG. 6 also suggests that mating between the individual pins in the pin system 52, and the individual pin receiver holes 53 in the pin receiver block 54, will only take place if all three of the keying elements have mechanically cooperated in a previously prescribed (“keyed”) manner to allow full insertion of the module 22 into the slot 24.

FIG. 7 shows the final results of the keying system 28 having successfully mechanically cooperated to allow the module 22 to be fully inserted into the module receiver slot 24 in chassis 26. The pin system 52 shown in FIGS. 5 and 6 now resides in the appropriate pin holes 53 of pin receiver block 54. Thus, the front end 62 of the receiver block 54 is shown abutting against the front end 63 of the module 22. Any one of several locking devices 23(A)/23(B) well known to this art can be used to lock the module 22 in the slot 24.

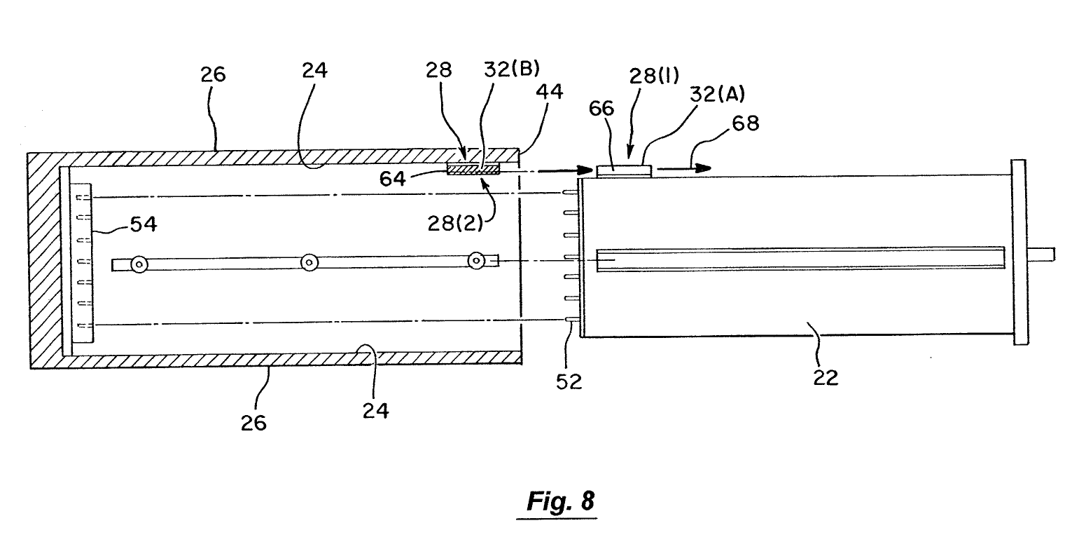

FIG. 8 is a cross sectional view showing key bit element 32(B) of chassis 26 in the form of a lug 64. This lug 64 is intended to pass through a lug keyway passage 66 in key bit element 32(A) of a first binomial keying element 28(1) mounted on module 22. This passage is also suggested by arrow 68. Thus, FIG. 8 illustrates the concept that a lug e.g., lug 64 can be a keying element for any (or all) of the key bit elements 30(B), 32(B) or 34(B) of a second binomial keying element 28(2) placed in the slot 24. Likewise, any or all of the key bit elements 30(A), 32(A) or 34(A) could be a passage (e.g., passage 66) for a lug such as lug 64. Thus, module installation “blockage” will be produced in situations where both key bit elements of a given bit (e.g., 32(A) and 32(B)) are both lugs.

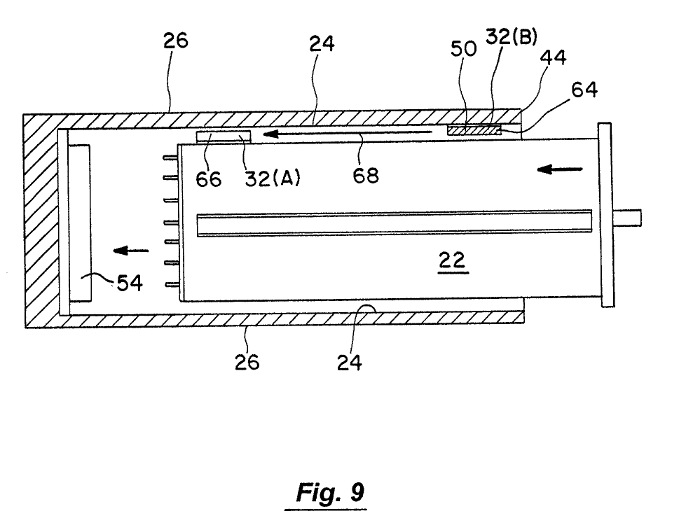

FIG. 9 is a cross sectional view showing successful passage of module 22 into the module-receiving slot 24 of chassis 26. Here again, this will only take place if the lug 64 that constitutes bit element 32(B) passes through the lug passage keyway 66 that constitutes key bit element 32(A). This outcome also assumes that the other two key bit elements shown in FIG. 3 (i.e., 30(B)/30(A) and 34(B)/34(A)) also have mechanically cooperated in a manner that allows full insertion of the module 22 into slot 24. Had key bit element 32(A) also been a lug, passage of the module 22 into the slot 24 would have been prevented.

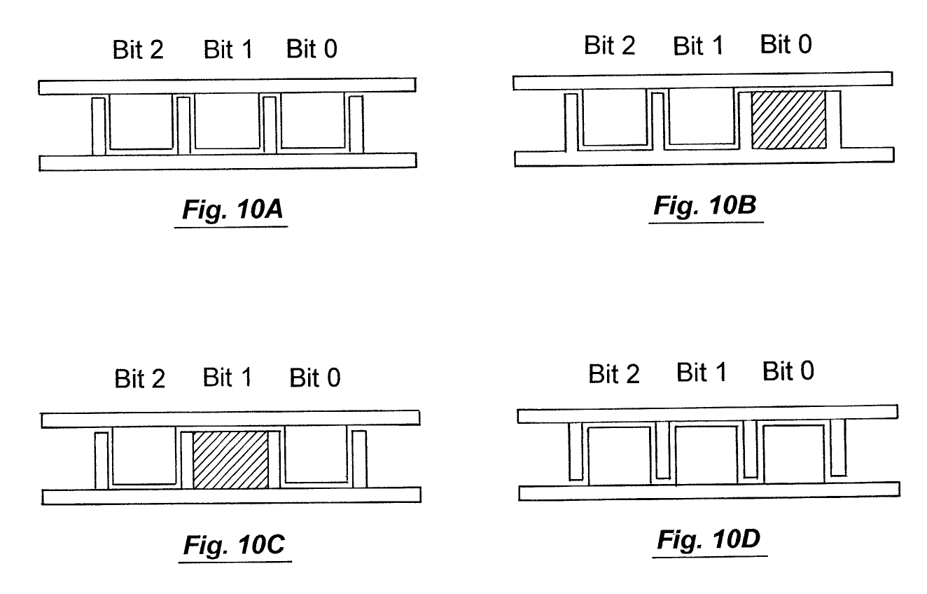

FIGS. 10A to 10D are intended to illustrate various generalized, representative, rule applications for the binary keys of a representative keying system 28 of this patent disclosure. In effect, it is the application of such rules that enable applicant's keying systems to perform their intended function (prevention of misinstallation of a module). For example, in the keying system 28 shown in FIGS. 10A to 10D, each bit location (Bit 0, Bit 1, Bit 2) must have either a bit element located on the chassis 26 or a bit element located on the module 22. If a bit location is not occupied on either the module or chassis, misinstallation of an alternate module may be possible—or that bit must be dropped from the calculation of the maximum number of keying possibilities. Obviously, the two sets of key bit elements 30(A), 32(A), and 34(A) and 30(B), 32(B), 34(B) must be physically aligned in the system so that no bit element affects an adjacent bit element.

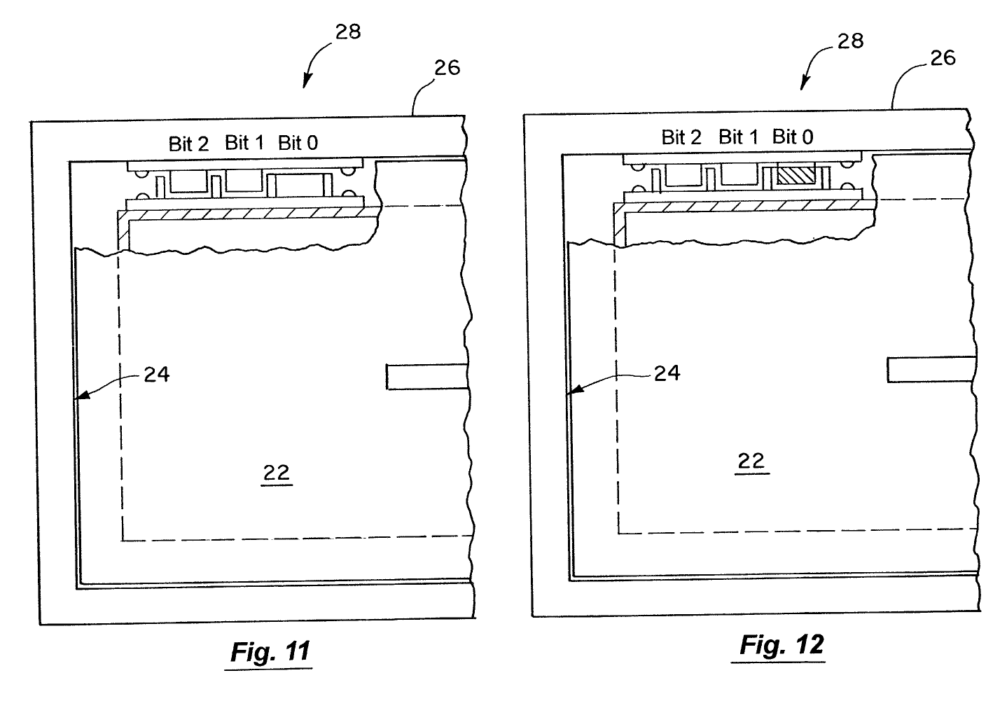

FIG. 11 illustrates a circumstance wherein a keying system 28 allows the correct module 22 to be installed in an appropriate keyed slot 24 of a chassis 26. By way of example only, FIG. 11 suggests that the slot 24 is intended to accept a module 22 with a key bit element for bit 0 installed. The module will therefore be keyed with bit 0 installed. Thus there will be no interference at this bit location. Assuming the other two bits of the three bit system cooperate in the manner in which they are keyed, the module 22 can be installed in its intended slot 24.

FIG. 12 illustrates a circumstance wherein a keying system will prevent an incorrect module 22 from being installed in a given keyed slot 24. For example, if Bit 0 of the module key is a lug, that lug is intended to pass through a passage in the slot key at the Bit 0 location. If the slot key at Bit 0 is also a lug there is an interference on bit 0 that will prevent the module from being installed. In other words, these two conflicting key bit elements (e.g., lugs) will collide and prevent misinstallation of the module 22.

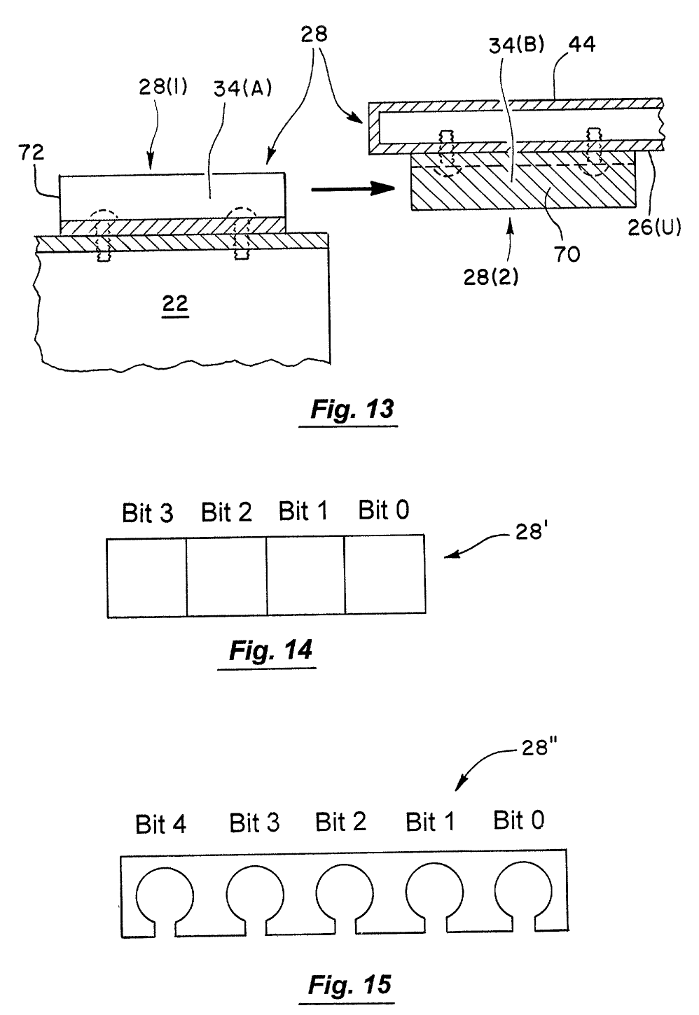

FIG. 13 shows a representative keying system 28 of this patent disclosure. A second binomial keying system element 28(2) includes a key bit element 34(B) mounted to the chassis 26. A cooperating key bit element 34(A) of a first binomial keying system element 28(1) is mounted to a module 22. Key bit element 34(B) is shown having a passage keyway element 70 through which a lug 72, mounted on module 22, can pass. The second binomial keying element 28(2) is shown mounted by bolts to the underside 26(U) of a chassis component. The second binomial keying element 28(2) containing key bit element 34(B) could be mounted through use of glue, magnetism or various lock or fastener means. In much the same way, the top surface of module 22 is shown provided with a first binomial keying element having a key bit element 34(A) that is secured to the top surface of the module 22 by means of two bolts.

FIG. 14 shows a binomial keying system 28′ having four bits (bits 0, 1, 2 and 3). Such a system is therefore capable of providing 2^{4 =}16 keying arrangements. It should also be noted that an initial three bit keying system having BIT 0,. BIT 1 and BIT 2 could be expanded by installing a fourth bit, Bit 3, by attaching it to the body of a binomial keying element containing the other three bits. Thus, the keying possibilities of the original three bit system can be expanded by adding a fourth bit (BIT 3), fifth bit, etc. to the binomial keying system.

FIG. 15 depicts a keying system 28″ wherein there are 5 bits (0, 1, 2, 3 and 4) having round, keywayed configurations. Since there are 5 such bits, this keying system 28″ is capable of providing 2⁵ or 3² different keying possibilities. Thus, FIG. 17 suggests that the rectangular lug/lug passage examples used previously can be replaced by keying elements having other geometries (e.g., round, triangular, etc.).

This invention has been described with reference to certain preferred embodiments. Substitutions and modifications will be apparent to those skilled in the art. In particular, the number of bits is not material to this invention. Similarly, lugs and lug passing passages have been used to illustrate the concepts of this invention, but any other types of mechanically cooperating elements could be utilized as well. Accordingly, it is intended that the invention not be limited except as provided by the appended claims.

I claim:

1. A module that further comprises a binomial keying system having 2^{X} keying possibilities where X is from 2 to 5 and wherein said binomial keying system is located on an outside surface of said module.

2. The module of claim 1 wherein the binomial keying system is positioned substantially at a rear end of said module.

3. The module of claim 1 wherein the binomial keying system is attached to said module late in a module manufacturing process.

4. The module of claim 1 wherein the binomial keying system is attached to said module at a module user site.

5. The module of claim 1 wherein the binomial keying system has three bits.

6. The module of claim 1 wherein the binomial keying system has four bits.

7. The module of claim 1 wherein the binomial keying system is comprised of lug and lug passage elements.

8. The module of claim 1 wherein the binomial keying system is comprised of 3 bits and wherein at least one of said 3 bits has a bit element in the form of a lug that passes through a lug passage keyway in said bit element.

9. The module of claim 1 wherein said module is a computer disk holding module.

10. The module of claim 1 further comprising a lock element for mechanically cooperating with another lock element on a module chassis in order to hold the module in a slot of said chassis.

11. A computer module system comprising:
a chassis having two or more substantially identically configured slots and wherein at least one of said two or more slots is provided with a keying element of a binomial keying system having from two to five bits; and
at least two computer modules each having substantially identical configurations and capable of being inserted into the two or more substantially identically configured slots in the chassis and wherein at least one of the at least two modules is provided with a keying element of a binomial keying system having from two to five bits that are capable of mechanically cooperating with the from two to five bits in the keying element of the binomial keying system provided to the chassis.

12. The computer module system of claim 11 wherein the keying element of the binomial keying system provided to the module is positioned substantially at rear end of said module.

13. The module of claim 11 wherein the binomial keying system is attached to said module late in a module manufacturing process.

14. The module of claim 11 wherein the binomial keying system is attached to said module at a module user site.

15. The computer module system of claim 11 wherein the binomial keying system has three bits.

16. The computer module system of claim 11 wherein the binomial keying system has four bits.

17. The computer module system of claim 11 wherein the binomial keying system is comprised of lug and lug passage elements.

18. The computer module system of claim 11 wherein the module further comprises a binomial keying system comprised of 3 bits and wherein at least one of said 3 bits has a key bit element in the form of a lug that passes through a lug passage in a keying element located in a slot in the chassis.

19. The computer system of claim 11 wherein the module is a computer disk holding module.

20. The computer module system of claim 11 further comprising a lock element for mechanically cooperating with another lock element on a module chassis in order to hold the module in a slot of said chassis.
